(19) United States
(12) Patent Application Publication
(10) Pub. No.: US 2013/0302822 A1
(43) Pub. Date: Nov. 14, 2013

(54) METHODS OF ANALYZING EXOSOMES USING FLUORESCENCE-LABELED EXOSOMES

(71) Applicant: SAMSUNG ELECTRONICS CO., LTD., Suwon-si (KR)

(72) Inventors: Myoung-soon KIM, Seoul (KR); Dong-hyun PARK, Chuncheon-si (KR); Chang-eun YOO, Seoul (KR); Ga-hee KIM, Yongin-si (KR)

(73) Assignee: SAMSUNG ELECTRONICS CO., LTD., Suwon-si (KR)

(21) Appl. No.: 13/768,680

(22) Filed: Feb. 15, 2013

(30) Foreign Application Priority Data
May 14, 2012 (KR) 10-2012-0051066

(51) Int. Cl. G01N 21/64

(52) U.S. Cl. CPC G01N 21/6486
USPC 435/7.9; 436/501

(57) ABSTRACT

A method of analyzing exosomes, the method comprising incubating a sample comprising fluorescence-labeled exosomes with a solid support so that the fluorescence-labeled exosomes bind to the solid support; measuring a fluorescence signal from the bound fluorescence-labeled exosomes; and analyzing the exosomes based on the measured fluorescence signal.

### CROSS-REFERENCE TO RELATED APPLICATION

This application claims the benefit of Korean Patent Application No. 10-2012-0051066, filed on May 14, 2012, in the Korean Intellectual Property Office, the entire disclosure of which is hereby incorporated by reference.

### BACKGROUND

1. Field

The present disclosure relates to methods of analyzing exosomes using fluorescence-labeled exosomes, particularly methods of analyzing exosome capture and exosome lysis.

2. Description of the Related Art

Exosomes are membrane-structured small vesicles secreted from several types of cells. Diameters of exosomes are reported to be about 30 nm to about 100 nm. In a study using a scanning electron microscopy, exosomes were observed to originate from specific intracellular compartments called multivesicular bodies (MVBs), and released and secreted out of a cell rather than separated directly from a plasma membrane. In other words, exosomes are vesicles that are released to the extracellular environment upon fusion of MVBs and the plasma membrane. Although the molecular mechanism involved in exosome production has not been clearly identified yet, red blood cells, various types of immune cells (including B-lymphocytes, T-lymphocytes, dendritic cells, blood platelets, and macrophages), and tumor cells are known to produce and secrete exosomes. Exosomes are secreted in both normal states and pathologic states.

Exosomes may contain microRNA (miRNA) which may be used as a marker in a molecular diagnostics, such as cancer diagnostics. However, exosomes are small in size and do not contain a large amount of miRNA as cells do. Therefore, it is important to isolate exosomes and separate and purify miRNA from the exosomes while minimizing loss.

A conventional method to measure the efficiency of exosome capture involves Western blotting using antibodies, but this method lacks convenience and sensitivity. Also, a conventional method to measure the lysis efficiency of exosomes involves measuring nucleic acids released by the exosomes using PCR or RT-PCR. However, this method is affected by inhibition, adsorption, etc., such that lysis efficiency cannot be precisely quantified.

In addition, lysis may be confirmed using scanning electron microscope (SEM) or dynamic light scattering (DLS). However, a method that uses SEM or DLS cannot quantitatively calculate exosome lysis (see FIG. 1).

Therefore, there is a need for additional methods to analyze exosomes.

### SUMMARY

Provided is a method of analyzing exosomes comprising incubating a sample containing fluorescence-labeled exosomes with a solid support so that the labeled exosomes bind to the solid support, measuring a fluorescence signal from the bound exosomes, and analyzing the exosomes based on the measured fluorescence signal. The method may be used, for example, to analyze exosome capture efficiency or exosome lysis efficiency.

### BRIEF DESCRIPTION OF THE DRAWINGS

These and/or other aspects will become apparent and more readily appreciated from the following description of the embodiments, taken in conjunction with the accompanying drawings of which:

FIG. 1A is a SEM image confirming exosome lysis using a scanning electron microscope (SEM), and FIG. 1B is a DLS graph confirming exosome lysis using dynamic light scattering (DLS).

FIG. 2A is an image showing results of Western blotting, and FIG. 2B is a graphical view showing the efficiency of exosome capture by using fluorescence-labeled exosomes on a solid support.

FIG. 3 is a bar graph showing the stability of exosomes captured on a solid support throughout a washing process.

FIG. 4 is a schematic illustrating the determination of exosome lysis efficiency (%) using fluorescence-labeled exosomes.

FIG. 5 is a bar graph showing exosome lysis efficiency (%) for chemical lysis and bead beating lysis.

FIG. 6 is a graph showing exosome lysis efficiency (%) for various concentrations of Triton X-100.

FIG. 7 is a graph showing the efficiency of exosome lysis (%) according to elution volume. Lysis efficiency: ♦—0.25% Triton X-100, ▪—0.5% Triton X-100. Relative concentration: ▴—0.25% Triton X-100, X—0.5% Triton X-100.

FIG. 8 is a graph showing exosome lysis efficiency (%) according to treatment time.

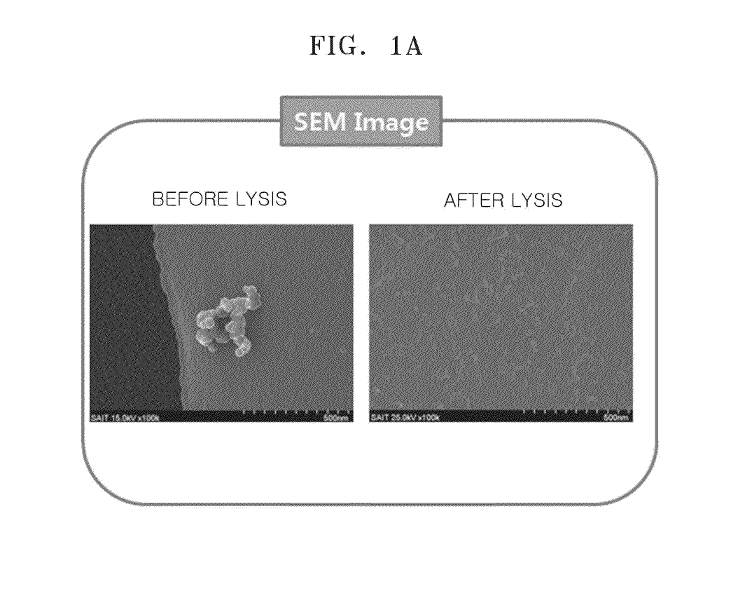

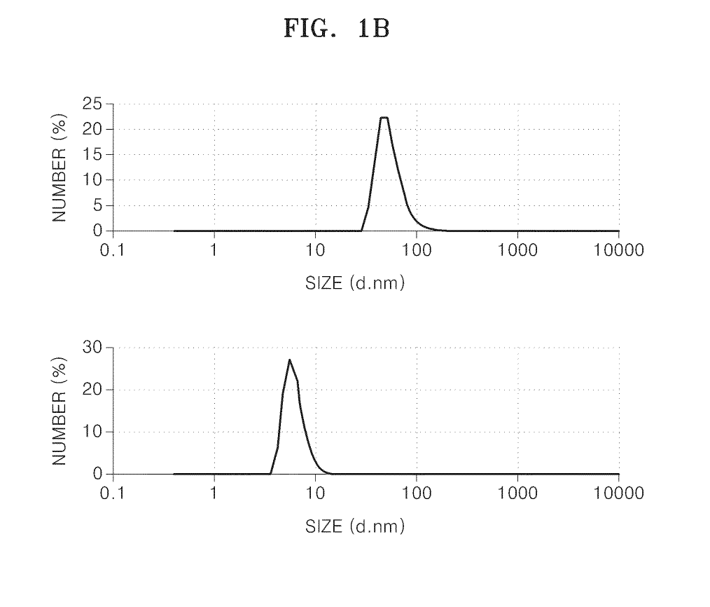

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

The terms “fluorescence” “fluorescence-labeled” and “fluorescent-labeled” refer to use of a substance that generates fluorescent light in response to physical or chemical treatment. Examples of the fluorescence include fluorescent protein such as green fluorescent protein (GFP), yellow fluorescent protein (YFP) or red fluorescent protein (RFP), photoprotein, and luciferase.

The fluorescent label may be contained inside the exosomes, or may be part of a fusion protein comprising a membrane protein and the fluorescent substance. In the fusion protein, the fluorescent substance may be connected to membrane protein directly or through a linker.

The term “membrane protein” refers to protein or glycoprotein present in the lipid bilayer of a cell membrane. The membrane protein may be integrated in the lipid bilayer or be situated on the surface of the lipid bilayer. For example, the membrane protein may be an enzyme, a peptide hormone, a receptor of autocrine, a carrier receptor of sugar or the like, an ion-channel, or a membrane antigen. In addition, the membrane protein may be protein that is present in exosomes; for example, EpCAM, CD63, CD81, Hsc70, MHC I, Tsg101, calnexin, or gp96. This membrane protein may be able to effectively position a fluorescent substance in an exosome. The fluorescent substance may be connected to the N-terminal or the C-terminal of a membrane protein, with or without a linker. The term “linker” refers to a peptide that connects a fluorescent substance and a membrane protein. The linker may be composed of any number of amino acids, for example, about 1 to about 50 amino acids or about 5 to about 20 amino acids.

The term “solid support” or “solid phase” refers to a stationary phase in chromatography. In column chromatography, the solid support may be an adsorbent (solid) loaded in a separating tube, or liquid impregnated in a carrier. In layer chromatography, the solid support may be liquid maintained in a carrier such as a filter paper. In affinity chromatography, the solid support may be an adsorbent material having specific affinity to a substance. Examples of a solid support include magnetic beads and polystyrene.

The solid support may include an exosome-binding substance. For example, an exosome-binding substance may be an antibody, but is not limited thereto. The exosome-binding substance may also be, for instance, phospholipids such as biotin-X DHPE or zwitterionic compounds such as sulfobetaine, phosphorylcholine, and carboxybetaine. The term “antibody” refers to a glycoprotein that specifically binds an antigen. The antibody may be an anti-EpCAM antibody.

The sample may be a biological sample containing exosomes (e.g., non-labeled exosomes), such as blood, serum, urine, mucus, saliva, tears, sputum, spinal fluid, hydrothorax, nipple aspirate, lymph fluid, airway fluid, intestinal fluid, genitourinary fluid, breast milk, fluid in lymphatic system, semen, cerebrospinal fluid, fluid in organ system, ascites, cystic neoplasm fluid, amniotic fluid, or a combination thereof. Fluorescently labeled exosomes may be added to the sample before, after, or simultaneously with incubation of the sample with the solid support. The fluorescently labeled exosomes may be added to the sample at a known concentration of arbitrary value. The sample may contain other exosomes which are not fluorescently labeled.

The method of analyzing exosomes may further include measuring a value of a fluorescence signal from a reactant obtained by the incubation (i.e., the complex of the labeled exosome bound to the solid support). Methods of measuring the fluorescence signal may vary depending on the type of fluorescence. For example, if the fluorescence is fluorescent protein, fluorescent light intensity caused by irradiation of ultraviolet may be measured by using a fluorophotometer. If the fluorescence is luciferase, fluorescent light intensity may be measured by using a luminometer.

A solid support that has not been incubated with fluorescence-labeled exosomes may be used as a control. A value of a fluorescence signal may be measured by subtracting the fluorescence value measured for the control from the fluorescence value measured for a solid support that has been incubated with fluorescence-labeled exosomes.

The method of analyzing exosomes may further include analyzing the exosomes based on the measured fluorescence signal value. Analysis of the captured fluorescent exosomes in this manner can, in turn, be used to analyze properties of the non-labeled exosomes in the sample. For instance, by analyzing the capture efficiency of the labeled exosomes, the capture efficiency of the process with respect to the non-labeled exosomes in a sample may be inferred. By way of illustration, since a known concentration of labeled exosomes is added to the sample, a capture efficiency of the labeled exosomes on the solid support can be established by analyzing the fluorescence of the exosomes on the support. Since the non-labeled exosomes are captured in the same process, using the same supports, the capture efficiency of the non-labeled exosomes can be inferred as approximately the same as that for the labeled exosomes. The same is true with respect to other properties of the labeled exosomes as may be measured, such as lysis efficiency.

The analyzing of the exosomes may comprise analyzing the binding of the exosomes to the solid support, i.e., analyzing exosome capture.

In addition, the method of analyzing exosomes may further include determining a detection limit of exosomes on the solid support based on the measured fluorescence signal. According to another embodiment, a detection limit of exosomes on the solid support may be represented as a capture efficiency of exosomes on the solid support. As described in Example 2, the lower the detection limit of exosomes on the solid support, the smaller the amount of exosomes detected. The smaller the amount of exosomes detected, the higher the capture efficiency of exosomes on the solid support. Thus, the detection limit of exosomes on the solid support may be represented as the capture efficiency of exosomes on the solid support.

In addition, the method of analyzing exosomes may further include a washing step following incubation of the exosomes and the solid support. More specifically, the reactant obtained from the incubation of the labeled exosomes and the solid support (e.g., the complex of the labeled exosomes bound to the solid support) may be washed to remove any substances not specifically bound to the support by way of the exosome binding material, and/or to determine the binding affinity or stability of the exosomes. For instance, the binding affinity or stability of the exosomes may be determined by comparing values of fluorescence signals measured before and after the washing step. The “stability” of exosomes means refers to the ability of exosomes to resist lysis or deformation when subjected to physical or chemical treatments. Washes of various stringencies may be used to further elucidate the binding affinity or stability of the exosomes.

In addition, the method of analyzing exosomes may further include subjecting the bound exosomes and solid support to one or more of lysis, bead beating, boiling, freezing, thawing, ultrasonication, or grinding (e.g., in liquid nitrogen). Such treatment may be used, for instance, to lyse the exosomes.

The term “lysis solution” refers to a solution containing a substance that lyses exosomes, such as a surfactant, a buffer solution of potassium ethyl xanthogenate (XS), or lysozyme, but the substance is not limited thereto. Examples of surfactants include SDS (sodium dodecylsulfate), Triton X-100, or cetyl trimethyl ammonium bromide (CTAB), but are not limited thereto.

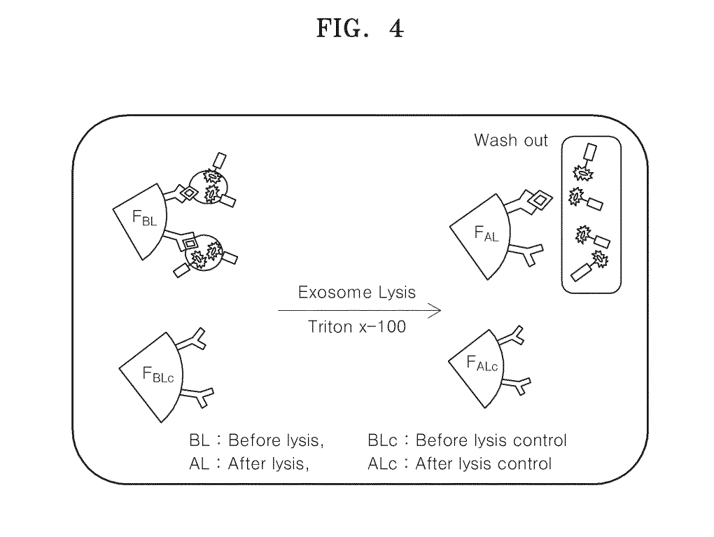

Measuring a value of a fluorescence signal may be conducted by measuring values of fluorescence signals before and after performing any process selected from the following: contacting a lysis solution, bead beating, boiling, freezing and thawing, ultrasonication, and grinding in liquid nitrogen. The values of fluorescence signals measured before and after performing any of the aforementioned processes may be compared to a control, i.e., a solid support that has not incubated with fluorescence-labeled exosomes, or a solid support that has been incubated with fluorescence-labeled exosomes but has not be subjected to one of the aforementioned processes. The results may be used to analyze exosome lysis, particularly the efficiency of exosome lysis. Conditions of exosome lysis are described, for example, in Examples 4-6 and FIG. 4.

For instance, efficiency of exosome lysis may be determined according to Equation 1, wherein “F” refers to fluorescence:

$$\begin{matrix}Exosome lysis efficiency ( \% ) = \frac{\{ ( {F}_{BL} - {F}_{BLc} ) - ( {F}_{AL} - {F}_{ALc} ) \}}{{F}_{BL} - {F}_{BLc}} \times 100 & [ Equation 1 ] \\ BL \text{:} Before lysis , & \\ BLc \text{:} Before lysis control & \\ AL \text{:} After lysis , & \\ ALc \text{:} After lysis control & \end{matrix}$$

The method of analyzing exosomes may further include determining a method of lysing exosomes based on the efficiency of exosome lysis determined by Equation 1. The lysis may be physical, chemical, or enzymatic lysis. The method of analyzing exosomes may further include analyzing the conditions of exosome lysis, including, for example, treatment concentrations, treatment time, or elution volume.

In addition, the method of analyzing exosomes may further include a washing step.

Optimum conditions for exosome capture or exosome lysis may be determined by analyzing the fluorescent-labeled exosomes on the solid support. Ideally, this method of analysis is fast, convenient way, and highly sensitive.

### EXAMPLE 1

### Preparation of Exosomes and Beads

### 1-1. Preparation of GFP-Labeled Exosomes

A vector to produce a CD63-GFP fusion protein (see SEQ ID NO. 2) was manufactured by inserting a CMV promoter and nucleic acids encoding a CD63-GFP fusion protein at a multi cloning site (MCS) in a pGL4.76 (AY864931) plasmid. Transfection of cells with the manufactured vector allows for the production of exosomes containing a CD63-GFP fusion protein.

The day before transfection, MCF-7 cells were evenly inoculated and incubated on a 150 mm plate. 7.5 ug of plasmid DNA was diluted in 7.5 ml of Opti-MEM serum-free medium (Invitrogen) and then completely mixed. After mixing Plus reagent (Invitrogen) completely, 75 ul of the Plus reagent was added into the diluted DNA, and was slowly mixed. Then the mixed solution was incubated for 5 minutes at room temperature. After mixing Lipofectamine™ LTX softly, 187.5 ul of Lipofectamine™ LTX was directly added into the incubated solution, which was then mixed completely. Then, the solution was incubated again for 30 minutes at room temperature.

On a plate containing MCF-7 cells (American Type Culture Collection; ATCC) to be transfected, the manufactured DNA-lipid complex was dropped slowly in drops. Then, the MCF-7 cells and the DNA-lipid complex were mixed by shaking the plate gently. The cells and DNA-lipid complex on the plate were incubated in CO₂ incubator for about 12 to 24 hours at 37° C. Next, the medium was exchanged with fresh exosome-free medium. A culture medium containing fetal bovine serum (FBS) was replaced with fresh medium including exosome-free FBS. Cells were cultured in CO₂ incubation for about 24 to 48 hours at 37° C., and then the conditioned medium was collected.

50 ul of the conditioned medium was put in a centrifuge tube, and the tube was centrifuged at 300×g for 10 minutes at 4° C. After having removed supernatant, precipitate was taken into a new centrifuge tube. Again, the tube was centrifuged at 300×g for 10 minutes at 4° C. After having removed supernatant again, precipitate was taken into a new centrifuge tube. Then, the tube was centrifuged at 2,000×g for 20 minutes at 4° C. The supernatant was transferred into a new polyallomer tube or a new polycarbonate bottle which is capable of ultra high-speed centrifugation. The tube or the bottle was centrifuged at 10,000×g for 30 minutes at 4° C. The supernatant was transferred into a new tube designed for ultra high-speed centrifugation. The tube was centrifuged at 110,000×g for 70 minutes at 4° C., and then the supernatant was completely removed. The pellet was re-suspended in 1000 ul of PBS inside the tube. Next, the tube was centrifuged at 100,000×g for 70 minutes at 4° C. The supernatant was removed as completely as possible. The pellet was re-suspended again in PBS inside the tube, and the tube was centrifuged at 100,000×g for 70 minutes at 4° C. The supernatant was removed as completely as possible. The pellet was re-suspended in a small amount of PBS or TBS. The contents of the tube were separated into aliquots of 100 ul and stored at −80° C.

### 1-2. Preparation of Beads to Separate Exosomes from a Sample

100 ul of Dynabeads M-270 Amine (Invitrogen) were washed twice in 200 ul of a buffer solution of 0.1M 2-morpholinoethanesulfonic acid (MES), 0.5M NaCl, and pH 6.0, and then re-suspended in 100 ul of the buffer solution. 48 ul of a 35% w/v polyacrylate (Aldrich) solution diluted to 1/10, was mixed with 236 ul of the buffer solution, added to the beads, and mixed well.

Next, 54 ul of 75 mg/ml ethyl-3-dimethyl-aminopropyl carbodiimide (EDC) solution (in distilled water) and 210 ul of 15 mg/ml n-hydroxysuccinimide (NHS) solution (in distilled water) were added to the beads and rotated for 1 hour. Next, the beads were washed twice in 400 ul of the buffer solution, and were re-suspended by 400 ul of the buffer solution.

The prepared beads were washed twice in 400 ul of a buffer solution of 0.025M MES and pH 6.0. 54 ul of 75 mg/ml EDC solution (in 0.025M MES, pH 6.0), 210 ul of 15 mg/ml NHS solution (in 0.025M MES, pH 6.0), and 236 ul of the buffer solution were added to the beads, mixed well, and rotated for 30 minutes. The beads were again washed twice in 400 ul of the buffer solution, and re-suspended by 400 ul of the buffer solution. Then 3 ul of protein G solution (10 ug/ul) was added and rotated for 1 hour. Then, 300 ul of polyethylene glycol (PEG) (molecular weight=5,000 Da, 20 ug/ul) was added to 39 ul of sulfobetaine (SB) (100 ug/ul in distilled water) and rotated for about 1 to 2 hours. Next, the beads were washed twice in 400 ul of 1X PBS (0.02% tween), and twice again in 400 ul of 1X PBS.

The prepared beads were washed twice in 400 ul of a buffer solution of 0.1M sodium acetate and pH 5.0. After mixing 160 ul of anti-EpCAM (R&D systems) and 340 ul of the buffer solution, the mixed solution was added to the beads and then rotated for 3 hours. Next, the beads were washed twice in 200 ul of 1X PBS (0.02% tween), twice again in 200 ul of 1X PBS, and then were re-suspended in 100 ul of 1X PBS.

The prepared beads were washed twice in 400 ul of a buffer solution of 0.1M sodium borate and pH 9.3. 400 ul of 20 mM DMP (in buffer, pH 9.3) was added to the beads and then rotated for 1 hour. Next, the beads were washed twice in 400 ul of a buffer solution of 50 mM ethanolamine, 0.1 M sodium borate, and pH 8.0, 200 ul of the buffer solution was added to the beads and rotated for 1 hour. Next, the beads were washed twice in 200 ul of 1X PBS (0.02% tween), twice again in 200 ul of 1X PBS, and were re-suspended in 100 ul of 1X PBS.

### 1-3. Capture of Exosomes

30 ul of the prepared beads were added to 300 ul of a mixture of serum (Sigma) and GFP-labeled exosomes (CD63-GFP exosomes), and then rotated at 30 rpm for 24 hours. The GFP-labeled exosomes were bound to anti-EpCAM antibodies bound to the beads, as described in Example 1-2. As a comparative experiment, exosomes were captured on the beads themselves. After removing the supernatant, the precipitates were washed 3 times in 200 ul of 1X PBS and then rotated for additional 3 hours in 300 ul of 1X PBS. After removing the supernatant, the precipitates were washed 3 times in 200 ul of 1X PBS, and then the beads were separated using a magnet.

### EXAMPLE 2

### Measurements of Efficiencies of Exosome Capture on Beads

It was evaluated how many exosomes present in a sample (serum, etc.) are captured on the beads.

Exosomes were captured on the beads according to the method of Example 1-3. Exosome detection limits were determined using both Western blotting and fluorescence detection. First, a detection limit was measured by performing Western blotting with anti-EpCAM antibodies. Second, a detection limit was measured by detecting fluorescence of a solution comprising 100 ul of GFP-analyzing buffer solution (Biovison) and GFP-labeled exosomes (CD63-GFP) captured on beads.

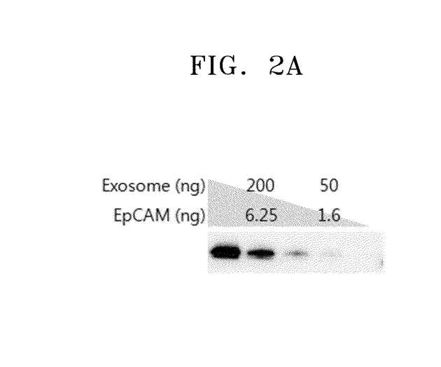

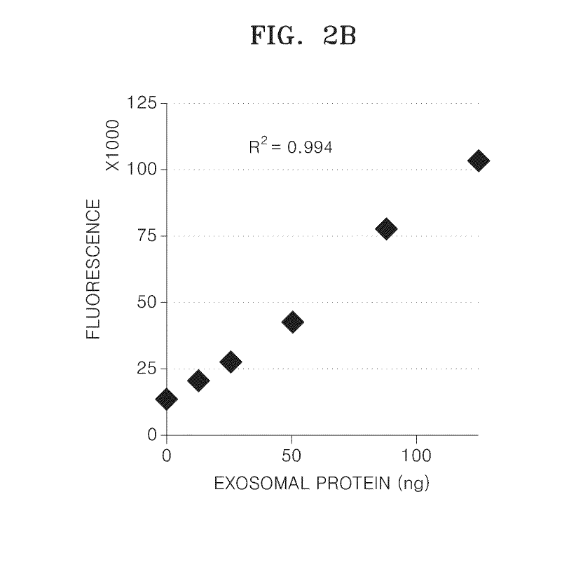

The detection limit of exosomes using Western blotting was 50 ng, but the detection limit of exosomes by detecting fluorescence of CD63-GFP was 12.5 ng, confirming that the fluorescence detection method is 4 times more sensitive (see FIG. 2).

### EXAMPLE 3

### Analysis of Exosome Stability Under Washing Conditions

After having captured GFP-labeled exosomes (490 ng) on the beads according to the method of Example 1-3, the beads were washed in 300 ul of 1X PBS for 0 hour, 1 hour, 2 hours, and 3 hours following addition of 100 ul of GFP-analyzing buffer solution (Biovison), and exosome stability was confirmed by measuring the fluorescence of the solution.

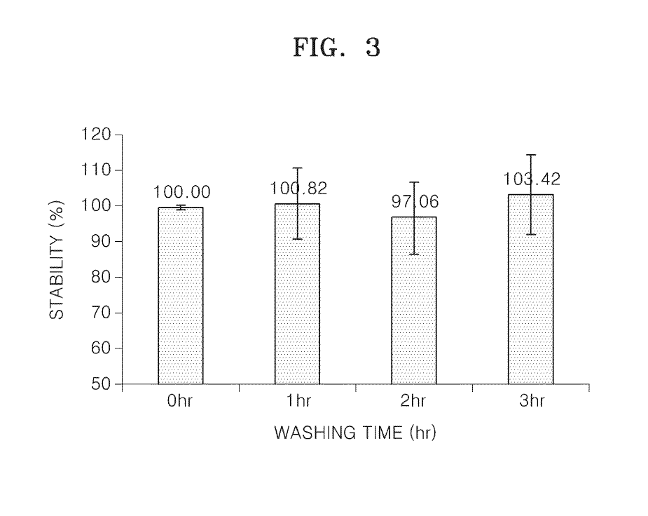

As a result, it was confirmed that exosome stability was maintained for 3 hours (see FIG. 3).

### EXAMPLE 4

### Measurements of Exosome Lysis and Efficiencies of Exosome Lysis

Exosome lysis was performed by adding 20 ul of 0.5% Triton X-100 solution (700 mM NaCl in PBS) to beads on which GFP-labeled exosomes were captured and incubating the mixture for 20 minutes at room temperature. After removing the supernatant, the beads were washed 3 times in 200 ul of 1X PBS.

100 ul of GFP-analyzing buffer solution (BioVision) was added to beads treated with Triton X-100 solution, as described above, and, separately, to beads not treated with Triton X-100 solution (control). After reacting the mixed solutions for 10 minutes at a room temperature, the beads were separated using a magnet. The fluorescence intensity of the solutions were measured by using a Beckman Couler DTX 800 apparatus, and the efficiency of exosome lysis was calculated using [Equation 1] (see FIG. 4).

$$\begin{matrix}Exosome lysis efficiency ( \% ) = \frac{\{ ( {F}_{BL} - {F}_{BLc} ) - ( {F}_{AL} - {F}_{ALc} ) \}}{{F}_{BL} - {F}_{BLc}} \times 100 & [ Equation 1 ] \\ BL \text{:} Before lysis , & \\ BLc \text{:} Before lysis control & \\ AL \text{:} After lysis , & \\ ALc \text{:} After lysis control & \end{matrix}$$

### EXAMPLE 5

### Determination of Methods of Exosome Lysis

Of methods of lysing exosomes, efficiencies of exosome lysis based on a chemical method and a physical method were compared.

After capturing GFP-labeled exosomes on the beads according to the method of Example 1-3, i) as a chemical method, 300 ul of lysis solution (Invitrogen) was added and the exosomes were lysed by vortexing for 15 seconds; or ii) as a physical method (bead beating), the prepared beads were rotated 30 cycles by using ExiSpin™ (vortexing and centrifugation), and each experiment was repeated 3 times.

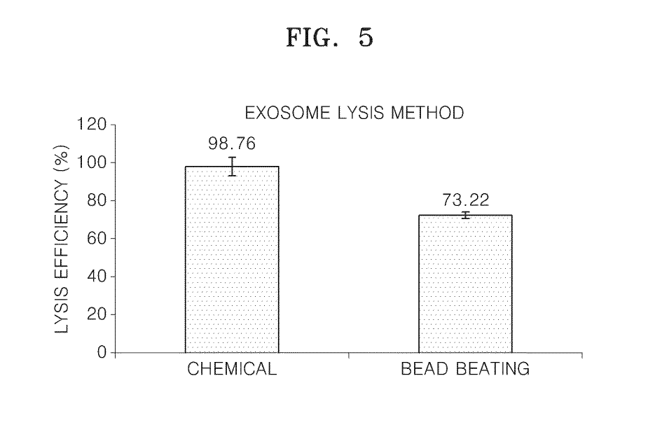

The efficiency of exosome lysis was calculated according to the method of Example 4. The efficiency of exosome lysis using the chemical method was 98.76%, and efficiency of exosome lysis using the physical method was 73.22%, confirming that use of the chemical method resulted in about 25% greater lysis (see FIG. 5).

### EXAMPLE 6

### Optimization of Lysis Conditions Regarding Chemical Methods of Exosome Lysis

### 6-1. Optimization of Concentration of Triton X-100

After capturing GFP-labeled exosomes on the beads according to the method of Example 1-3, exosomes were lysed under the following conditions. Each experiment was repeated 3 times.
Condition: medium—distilled water,
treatment time—30 minutes,
concentration of Triton X-100—from about 0 to about 2%, and
elution volume—50 ul.

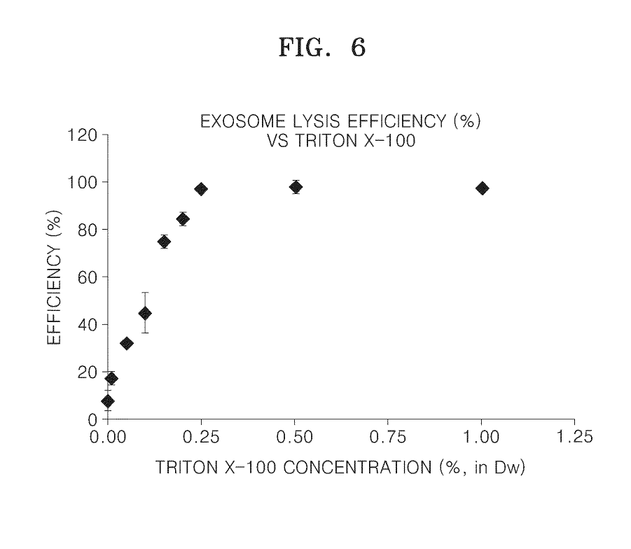

Exosome lysis efficiency was calculated according to the method of Example 4. As a result, at a concentration of 0.25% Triton X-100, it was confirmed that exosome lysis efficiency was saturated up (see FIG. 6).

### 6-2. Optimization of Elution Volume

After capturing GFP-labeled exosomes on the beads according to the method of Example 1-3, exosomes were lysed under the following conditions. Each experiment was repeated 3 times.
Condition: medium—distilled water,
treatment time—30 minutes,
concentration of Triton X-100—from about 0 to about 0.5%, and
lysis volume—from about 10 ul to about 50 ul.

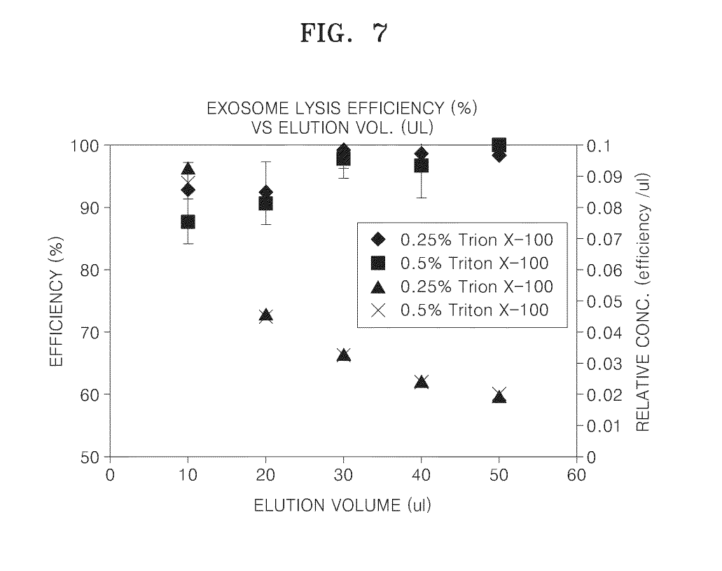

Exosome lysis efficiency was calculated according to the method of Example 4. As a result, even when elution volume was reduced to 10 ul, lysis efficiency remains more than 90%. It was confirmed that lysis efficiency by elution volume was greatest when elution volume was 10 ul (see FIG. 7).

### 6-3. Optimization of Treatment Time

After capturing GFP-labeled exosomes on the beads according to the method of Example 1-3, the exosomes were lysed under the following conditions. Each experiment was repeated 3 times.
Condition: medium—distilled water,
treatment time—from about 0 minutes to about 30 minutes.
concentration of Triton X-100—from about 0 to about 0.25%, and
elution volume—10 ul

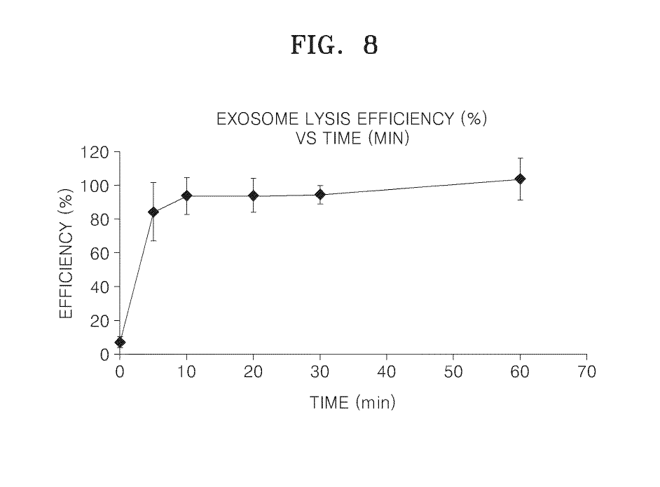

Efficiency of exosome lysis was calculated according to the method of Example 4. As a result, it was confirmed that efficiency of exosome lysis was maintained at 90% or more for a treatment time of 10 minutes or more (see FIG. 8).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of analyzing exosomes, the method comprising:
incubating a sample comprising fluorescence-labeled exosomes with a solid support so that the fluorescence-labeled exosomes bind to the solid support;
measuring a fluorescence signal from the bound fluorescence-labeled exosomes; and
analyzing the exosomes based on the measured fluorescence signal.

2. The method of claim 1, wherein a fluorescence is fluorescent protein, photoprotein, or luciferase.

3. The method of claim 2, wherein the fluorescent protein is green fluorescent protein (GFP), yellow fluorescent protein (YFP), or red fluorescent protein (RFP).

4. The method of claim 1, wherein the fluorescence-labeled exosomes comprise a fusion protein comprising a membrane protein and a fluorescence material.

5. The method of claim 4, wherein the membrane protein is EpCAM, CD63, or CD81.

6. The method of claim 1, wherein the solid support is a magnetic bead or a polystyrene.

7. The method of claim 1, wherein the solid support comprises an exosome-binding substance.

8. The method of claim 7, wherein the exosome-binding substance is an antibody.

9. The method of claim 8, wherein the antibody is an anti-EpCAM antibody.

10. The method of claim 1, wherein analyzing the exosomes comprises analyzing the binding between the exosomes and the solid support.

11. The method of claim 1, further comprising determining a detection limit of exosomes bound to the solid support.

12. The method of claim 1, further comprising washing the solid support comprising bound fluorescence-labeled exosomes.

13. The method of claim 1, further comprising:
subjecting the solid support comprising bound fluorescence-labeled exosomes to contact with a lysis solution, bead beating, boiling, freezing, thawing, ultrasonication, grinding in liquid nitrogen, or a combination thereof.

14. The method of claim 1, further comprising contacting the solid support comprising bound fluorescence-labeled with a lysis solution comprising a surfactant, a buffer solution of potassium ethyl xanthogenate (XS), a lysozyme, or combination thereof.

15. The method of claim 14, wherein the surfactant is sodium dodecylsulfate (SDS), Triton X-100, or cetyl trimethyl ammonium bromide (CTAB).

16. The method of claim 13 comprising measuring a value of a fluorescence signal before and after subjecting the solid support comprising bound fluorescence-labeled exosomes to contact with a lysis solution, bead beating, boiling, freezing, thawing, ultrasonication, grinding in liquid nitrogen, or a combination thereof.

17. The method of claim 13, wherein the method is used to analyze exosome lysis.

18. The method of claim 16, wherein the method is used to determine efficiency of exosome lysis based on the measured fluorescence signal value.

19. The method of claim 1, wherein the sample is a biological sample from a patient comprising non-labeled exosomes.

20. The method of claim 1, wherein the sample is blood or blood serum.

21. The method of claim 19, wherein the method further comprises adding fluorescence-labeled exosomes to the sample before or during incubation of the sample with the solid support.
